(19) United States
(12) Patent Application Publication
(10) Pub. No.: US 2019/0319490 A1
(43) Pub. Date: Oct. 17, 2019

(54) METHOD AND DEVICE FOR WIRELESS CHARGING OF ELECTRICAL ENERGY STORAGE IN A FIXED OR MOBILE CONSUMER

(71) Applicant: FOLQUER HOLDINGS LIMITED, Nicosia (CY)

(72) Inventors: Oleg Vladimirovich Trubnikov, Moskva (RU); Vladimir Zakharovich Trubnikov, Moskva (RU); Andrej Borisovich Tarasov, Moskva (RU)

(21) Appl. No.: 16/287,446

(22) Filed: Feb. 27, 2019

(30) Foreign Application Priority Data
Apr. 16, 2018 (RU) 2018113768

(51) Int. Cl. H02J 50/12; H01F 27/00; H01F 27/28; B60L 53/126; H04B 5/00

(52) U.S. Cl. CPC H02J 50/12; H01F 27/006; H04B 5/0093; B60L 53/126; H04B 5/0037; H01F 27/2823

(57) ABSTRACT

A method of wireless charging of electrical energy storage of a fixed or mobile power consumer includes the step of transmitting electrical energy from a power source to the electrical energy storage of the fixed or mobile power consumer using a controlled and frequency-adjustable electrical current converter for conversion from a power source format to a high frequency AC current format. The method includes the step of including a transmitter and a receiver with magnetic resonance coupling and a current converter for conversion from the high frequency AC current format into a current format required for normal operation of the electrical energy storage being charged. Energy transmission is arranged between the transmitter and the receiver using an electromagnetic field.

### CROSS-REFERENCE TO RELATED APPLICATION

This patent application claims priority to Russian Patent Application No. 2018113768 filed on Apr. 16, 2018, the disclosure of which is incorporated herein by reference in its entirety.

### FIELD OF THE INVENTION

The invention refers to the electrical industry and specifically, to methods and devices for wireless transmission of electrical energy, using resonant half-wave technologies between fixed power units and mobile devices that receive electrical energy.

### BACKGROUND OF THE INVENTION

Methods and devices with wireless energy transmission from a fixed transmitter to a fixed or mobile power consumer are classified as closely and loosely coupled objects. Closely coupled methods and systems ensure minimum energy losses. A drawback of closely coupled wireless energy transmission systems is the need to ensure precise relative positioning with regard to the power transmitter and receiver. The coupling factor in closely coupled systems must be brought up to values close to 100 percent.

Even if the coupling factor is less than 10%, loosely coupled methods and systems can achieve efficiency of 0.8 or more with significantly lower requirements for the relative positioning of the transmitter and receiver, due to the resonant properties of the transmitter and receiver. An electromotive force can get excited both in loosely and closely coupled transmitters and receivers, mainly due to the variables of electrical or magnetic fields. Transmission systems are also classified as resonant and non-resonant.

There is a known method and device for transmission of electrical energy (Russian patent No. 2411142 dated 10 Feb. 2011, Bulletin No. 4) to electrical vehicles, cell phones and other electronic devices transmitting electrical energy from a resonant power supply system via a high voltage, high frequency transducer at resonant frequency of f₀, a single-wire line and air gap to individual current collectors of the consumer; electrical energy is transmitted using the electric induction method at a frequency in the range of 0.1-1000 kHz at line voltage of 0.1-1000 kV through an air gap between two conducting wires shielded on the outer side with air capacitor plates; one of the plates is radiating and connected to shielded and insulated single-wire line; the capacity of the insulated shield of a single-wire line is compensated at resonant frequency of f₀ with inductance by the connection of inductance to shield and ground; the receiving plate receives energy and is integrated into the current collector of the consumer and connected to the electrical load via resonant loop, rectifier and charger.

A drawback of the known method is the need to use high potential (up to 1000 kV) on the power transmitter and receiver.

The closest solution to the problem of contactless energy transmission to fixed or mobile receivers is a contactless method of providing power supply to electrical vehicles (Russian patent No. 2505427 dated 10 Jul. 2013. Bulletin No. 19). According to the patent for the known method of providing power supply to electrical vehicles, comprising a power supply from a high frequency current source to a transmission system located on a road surface, which is received by the electrical equipment of the electrical vehicles; the frequency and voltage of the electrical energy from the electrical network are converted and resonant current and voltage oscillations are created in the transmitting power supply system at the natural resonant frequency of the electrical circuit in the electrical vehicle. Meanwhile, the electrical energy is fed in resonant mode via a high-frequency feeder to transmission winding. The transmission (supply) winding is located on a road surface and includes a flat rectangular single-layer winding of insulated wire, with displacement of each winding turn by a winding wire diameter. An electromagnetic field is created in both parts of the transmission winding when an alternating high frequency current passes through them; the electromagnetic energy density vector is oriented and directed on top of the transmission winding, and the receiving windings in the form of spiral coils are located on the electrical vehicle along the circumference of the rubber wheels while moving along or standing still on the road surface. The electrical vehicle shall be also equipped with rectangular receiving winding located on and secured to an electrically insulated plate, which in turn is secured to the bottom of the vehicle body and located parallel to the road bed with an air gap above both parts of the transmission winding. The windings on the electrical vehicle receive electromagnetic energy, which is fed to the energy storage via a rectifier.

A drawback of the known contactless method of providing power supply to electrical vehicles is the high irregularity of magnetic induction flux transversal to the conductors, which makes the requirements for the accuracy of the receiver positioning transversal to the winding conductors more stringent.

### SUMMARY OF THE INVENTION

An objective of the proposed invention is to create a wireless method and system for charging energy storage in a fixed or mobile electrical consumer that has a uniform intensity of magnetic flux at the active area of the transmitter, a high efficiency with regard to energy transmission, and a low radiation level.

The proposed invention offers the possibility for the wireless charging of an electrical energy storage in a fixed or mobile electrical consumer, i.e.: charging and recharging electrical energy storages in vehicles during movement or at special wireless charging stations, when a mobile electrical consumer is present at a road crossing with traffic lights, etc., charging and recharging energy storages in mobile phones, laptops, tablet PCs in large rooms, charging and recharging energy storages in quadcopters, automated logistical systems of cargo movement in large warehouses and bases and storages under operating conditions of automatic systems where presence of people is undesirable (warehouses with very low operating temperatures, warehouses with special composition of ambient environment, etc.)

The technical effect is achieved through a method of wireless charging of electrical energy storage in a fixed or mobile power consumer comprising electrical energy transmission from the power source to the power receiver at the power consumer, using a controlled and frequency-adjustable electrical current converter for conversion from the power source format to the high-frequency AC current format, and including a transmitter and receiver with magnetic resonance coupling, a current converter for conversion from high frequency magnetic resonance winding of the transmitter includes a flat spiral with double-wire winding from the center to periphery. The magnetic resonance winding of the receiver includes a flat single-wire spiral. The magnetic resonance winding of the transmitter is used for excitation of current and potential standing waves with maximum current at the periphery in the magnetic resonance winding of the transmitter. Energy transmission is arranged between the transmitter and the receiver, using the electromagnetic field of current standing wave—for this purpose, the leads in the central part of the transmitter double-wire spiral winding are connected to the output terminals of converters with high and adjustable frequencies. The leads of the single-wire spiral winding at the receiver of a fixed or mobile consumer are connected to the converter for conversion of high frequency current into a format required for normal operation of the energy storage being charged.

In another method of wireless charging for energy storage of a fixed or mobile power consumer, the magnetic resonance winding of the transmitter includes a flat double-wire spiral with winding turns running from the center to the periphery. The natural resonant frequency of the double-wire winding in the receiver is equal to the resonant frequency of the flat double-wire winding in the transmitter. The leads in the central part of the double-wire spiral winding in the receiver are insulated from each other and from the other conductive parts and components of the receiver. The leads from the periphery of the spiral double-wire winding are connected with the input of the converter for conversion of high frequency current into the current required for normal operation of the energy storage being charged. The output terminals are connected to the incoming terminals of the energy storage at the receiver.

In yet another method of wireless charging of electrical energy storage in a fixed or mobile power consumer, the peripheral leads of the flat double-wire spiral winding in the transmitter are short-circuited, and power from the converter output is fed to the flat double-wire spiral winding of the transmitter using a magnetic coupling coil; the magnetic coupling coil covers the double-wire spiral winding of the transmitter at the periphery, on the plane of the double-wire spiral winding.

In another method of wireless charging of electrical energy storage in a fixed or mobile power consumer, the magnetic coupling coil of the flat double-wire spiral winding in the transmitter is connected to the current converter output via a capacitor forming a resonant loop with the coupling coil. The natural resonant frequency of the series resonant loop is equal to the resonant frequency of the flat double-wire spiral winding of the transmitter.

In yet another method of wireless charging of electrical energy storage in a fixed or mobile power consumer, the single-wire flat spiral winding of the receiver is connected to the converter input for converting a high frequency current into the format required for operation of energy storage, via a capacitor forming a series resonant loop with the single-wire flat spiral winding of the receiver. The resonant frequency of the formed loop is equal to the resonant frequency of the flat double-wire winding in the transmitter.

In yet another method of wireless charging of electrical energy storage in a fixed or mobile power consumer, the magnetic coupling coil for transmission of electrical energy from the current converter output to the flat double-wire spiral winding of the transmitter is in the form of two circular half-windings located along the periphery, at opposite ends of the flat double-wire spiral winding. The circular half windings are electrically interconnected in series and consistently.

A device for wireless charging of energy storage in a fixed or mobile consumer comprises a power source coupled to a controlled and frequency-adjustable converter for conversion of a current from the power source format into a high frequency alternating current format, a transmitter and a receiver with magnetic resonance coupling, and a converter for conversion of a current from a high frequency current format into the format required for normal operation of the energy storage being charged. The magnetic resonance winding of the transmitter includes a flat spiral with double-wire winding from the center to the periphery. The magnetic resonance winding of the receiver includes a flat single-wire spiral. The electrical energy is transferred between the magnetic resonance winding of the transmitter and the magnetic resonance winding of the receiver using an electromagnetic field. The peripheral leads of the magnetic resonance winding are connected to the output terminals of the frequency converter for converting the current from the electrical energy source format into a high frequency current format. The leads of the central part of the double-wire spiral winding are insulated from each other and from the other conductive parts and components of the transmitter. The leads of the single-wire spiral winding at the receiver are coupled to the input terminals of the converter for converting a high frequency current into the format required for normal operation of the energy storage being charged; the output terminals of the converter are connected to the terminals of the energy storage in the receiver of a fixed or mobile consumer.

In another device for wireless charging of energy storage in a fixed or mobile consumer, the magnetic resonance winding of the receiver represents a double-wire spiral with winding turns running from the center to the periphery. The leads in the central part of the double-wire spiral winding in the receiver are insulated from each other and from the other conductive parts and components of the receiver. The leads from the periphery of the spiral double-wire winding are connected to the input of the converter for conversion of high frequency current into the current required for normal operation of the storage being charged. The output terminals of the converter are connected to the input energy storage terminals; the natural resonant frequency of the double-wire winding in the receiver is equal to the resonant frequency of the flat double-wire spiral winding of the transmitter.

In yet another device for wireless charging of the energy storage in a fixed or mobile consumer, the peripheral leads of the double-wire spiral winding in the transmitter are short-circuited. A magnetic coupling coil for coupling of the flat double-wire spiral winding with the frequency converter is located on the plane of the double-wire spiral winding. The coupling coil leads are connected to the output terminals of the frequency converter for conversion of current from the power source format into a high frequency current format.

In yet another device for wireless charging of the electrical energy storage in a fixed or mobile power consumer, the coil of the magnetic coupling of the flat double-wire spiral winding in the transmitter is connected to the current converter output via a capacitor forming an oscillating loop with the coupling coil. The natural resonant frequency of the series resonant loop is equal to the natural resonant frequency of the flat double-wire spiral winding of the transmitter.

In yet another device for wireless charging of electrical energy storage in a fixed or mobile power consumer, the leads of the single-wire flat spiral winding of the receiver are connected to the input terminals of the converter for conversion of a high frequency current into the current format required for operation of energy storage, via a capacitor forming a series resonant loop with the single-wire flat spiral winding. The resonant frequency of the series resonant loop of the receiver is equal to the resonant frequency of the flat double-wire winding in the transmitter.

In yet another device for wireless charging of electrical energy storage in a fixed or mobile power consumer, the magnetic coupling coil with frequency converter of the flat double-wire spiral winding includes two circular half-windings. The half-windings are located along the periphery at opposite ends of the flat double-wire spiral winding, and the half-windings are interconnected in series and consistently.

### BRIEF DESCRIPTION OF THE DRAWINGS

The essence of proposed methods and systems is illustrated in FIGS. 1-6.

FIG. 1 shows an electrical diagram of the method and device for wireless charging of energy storage in a fixed or mobile power consumer, entailing transmission of electrical energy from the power source to the power receiver at the consumer, whereas magnetic resonance winding at the transmitter represents a flat spiral with double wire winding from center to periphery. The leads of the double-wire winding are insulated from each other in the central part and the leads of the double-wire winding periphery are connected to the frequency converter for excitation of current and potential standing waves in the winding.

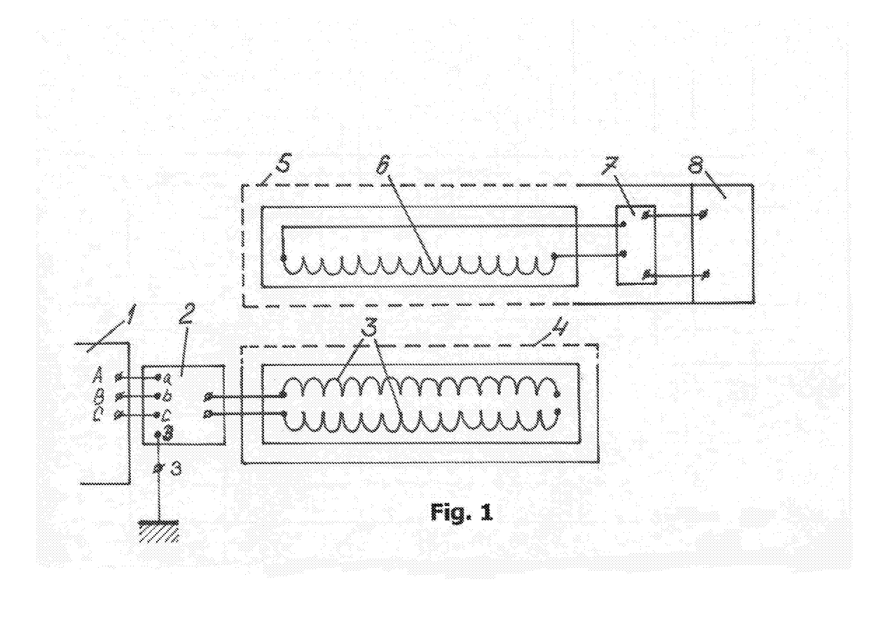

FIG. 2 shows an electrical diagram of the method and device for wireless charging of energy storage in a fixed or mobile power consumer, entailing transmission of electrical energy from the power source to the power receiver at the consumer, whereas magnetic resonance winding at the receiver represents a flat double wire spiral with winding from center to periphery. Leads of the central part of double-wire spiral winding are insulated from each other, and the outputs of the winding periphery are connected to the frequency converter for converting the high frequency current into the format needed for operating the energy storage.

FIG. 3 shows an electrical diagram of the method and device for wireless charging of energy storage in a fixed or mobile power consumer, entailing transmission of electrical energy from the power source to the power receiver at the consumer. The peripheral leads of the flat double-wire spiral winding in the transmitter are short-circuited, and the power is transmitted from the converter output into the flat double-wire spiral winding of the transmitter, using a magnetic coupling coil, which covers the double-wire spiral winding of the transmitter at the periphery on the winding surface.

FIG. 4 shows an electrical diagram of the method and device for wireless charging of energy storage in a fixed or mobile power consumer, entailing transmission of electrical energy from the power source to the power receiver at the consumer. The magnetic coupling coil of the flat double-wire spiral winding in the transmitter is connected to the current converter output via capacitance that forms a series resonant loop with the coupling coil.

FIG. 5 shows an electrical diagram of the method and device for wireless charging of energy storage in a fixed or mobile power consumer, entailing transmission of electrical energy from the power source to the power receiver at the consumer. The single-wire flat spiral winding of the receiver is connected to the converter for converting the high-frequency current into the current format needed to operate the energy storage at the receiver via a capacitor that forms a series resonant loop with single-wire flat spiral winding of the receiver.

FIG. 6 shows an electrical diagram of the method and device for wireless charging of energy storage in a fixed or mobile power consumer, entailing transmission of electrical energy from the power source to the power receiver at the consumer. The magnetic coupling coil for transmission of power from the current converter output into flat double-wire spiral winding of the transmitter is formed by two circular half-windings located along the periphery, at opposite ends of the flat double-wire spiral winding.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner.

The device contains power source 1. 380V/3p/50 Hz to HF (1.0-30.0 kHz) single phase current converter 2 is connected to terminals of the power source 1. A current frequency at the converter 2 output can be adjusted by the operator or automatically. The frequency output of the converter 2 is connected to peripheral leads of a flat double-wire spiral winding or double-wire quarter-wave winding 3. The Central leads of the flat double-wire spiral winding 3 are insulated from each other and from the conductive parts and components of a transmitter 4. The flat double-wire spiral winding 3 embodied as described above represents a long open-ended line coiled into a flat spiral powered from the converter 2 which is a frequency-adjustable frequency converter. If the converter 2 is set to the frequency of the quarter-wave resonance of the double-wire spiral winding 3 along the long line coiled into a double-wire spiral, the current and potential standing waves get excited with the current maximum in the center between the insulated leads and the current maximum at the peripheral leads to which the output terminals of the converter 2 are connected. The minimum current is formed at the open and insulated leads of the double-wire spiral winding 3, and the minimum potential is excited at the input peripheral leads of the double-wire spiral winding 3. For this layout of current and potential minimums and maximums in the double-wire spiral winding 3, the magnetic field in the double-wire spiral winding 3 does not reduce towards the winding periphery due to the location of the minimum current at the periphery of the double-wore spiral winding 3, which enables the electromagnetic field at the periphery to participate effectively in energy transmission to an electromagnetic receiver unit of single-wire spiral winding 6 of an energy receiver 5. The energy excited in the single-wire spiral winding 6 is transmitted via converter 7 from high frequency current energy into energy with the current format needed for normal operation of a power storage 8 at the energy receiver 5. The flat single-wire spiral winding 6 functions as a normal non-resonant winding placed in an electromagnetic alternating field of the double-wire spiral winding 3 of the transmitter 4.

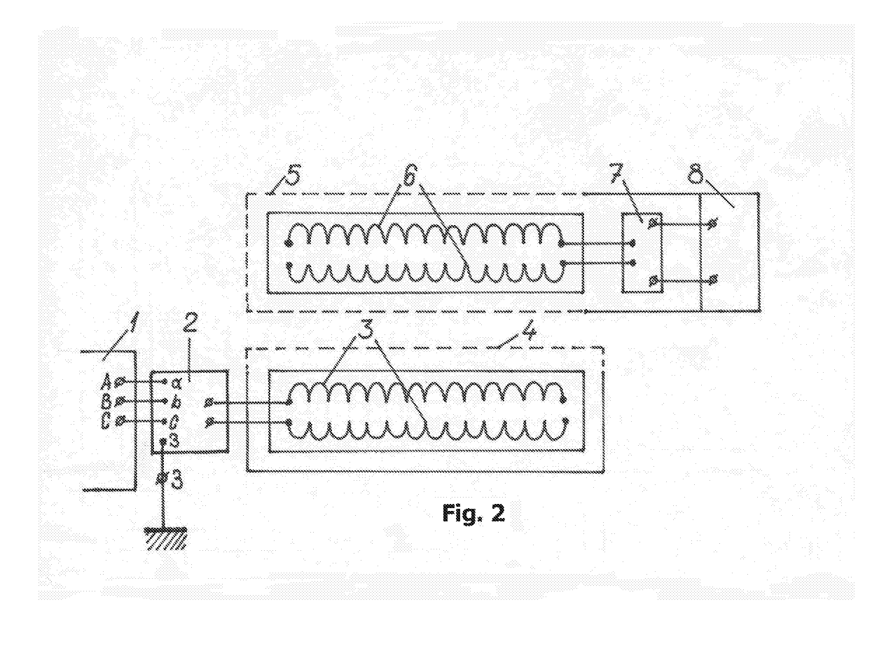

FIG. 2 illustrates the single wire spiral winding 6 as a flat double-wire spiral winding 6. When the leads in the central part of the single wire spiral winding are disconnected, the flat double-wire spiral winding 6 in the receiver 5 at FIG. 2 starts functioning as a coiled spiral opened at the end of the double-wire long line, the same way that the flat double-wire spiral winding 3 functions in the transmitter 4. The maximum potential is excited at the central part of the double-wire spiral winding 6 and the maximum current is excited at the periphery of the double-wire spiral winding 6. Therefore, maximum induction of magnetic flux in the double-wire spiral winding 6 is excited at the periphery of the double-wire spiral winding 6, which ensures a high regularity of energy flux density along the entire area of the double-wire spiral winding 3.

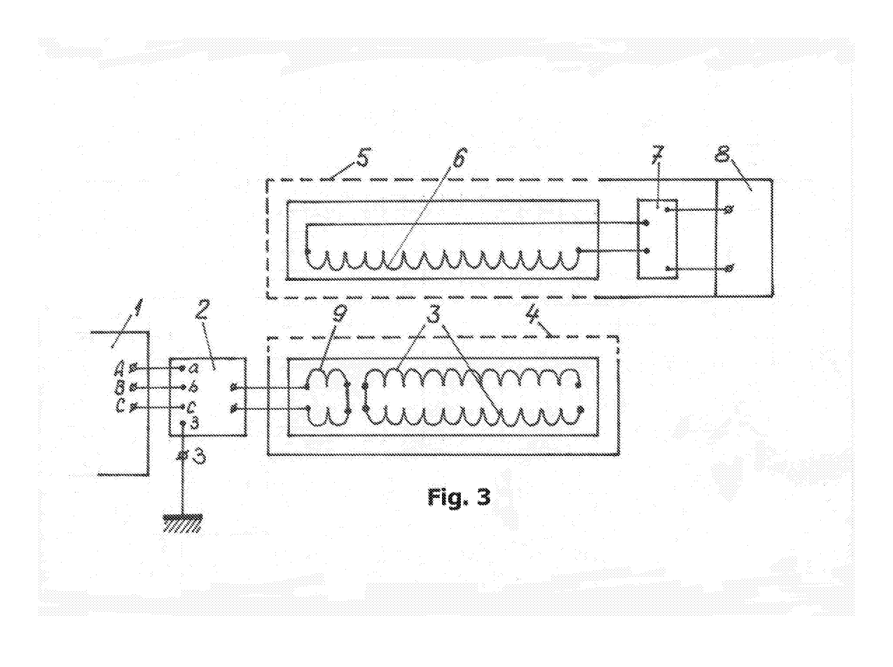

The connection of peripheral leads in the flat double-wire spiral winding 3 of the transmitter 4 at FIG. 3 ensures galvanic isolation of the flat double-wire spiral winding 3 from industrial AC mains, which significantly reduces injury hazard from the charger for operating personnel of energy storages and for users of the charging station and wireless charger of fixed and mobile power consumers.

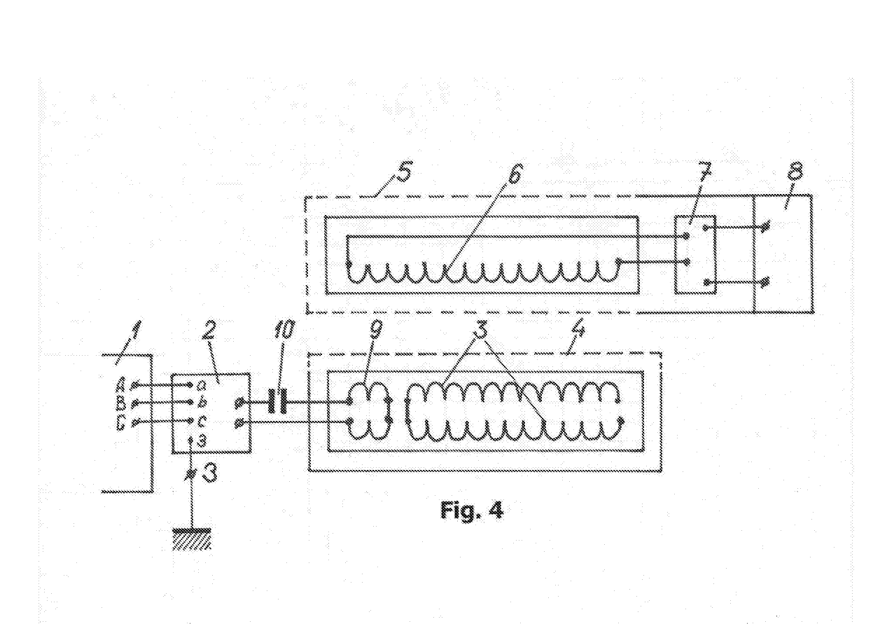

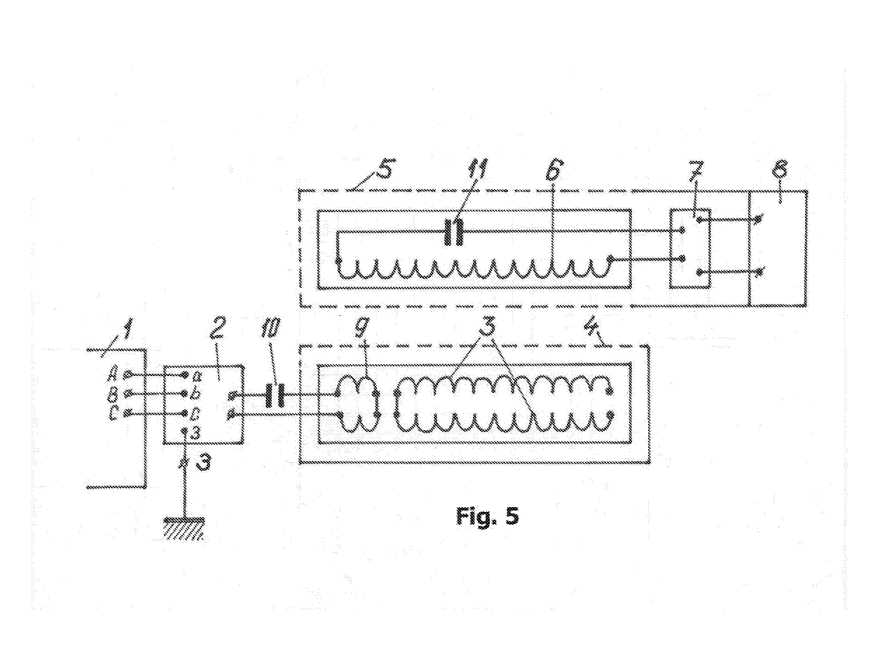

The connection to supply and drainage loops of the transmitter 4 and the receiver 5 of capacitors 10 and 11, as shown in FIG. 4 and FIG. 5, creates the necessary conditions for the appearance of series resonance for pumping energy into a supply coupling winding 9 in the transmitter 4 and draining energy from the single-wire spiral winding 6 in the receiver 5.

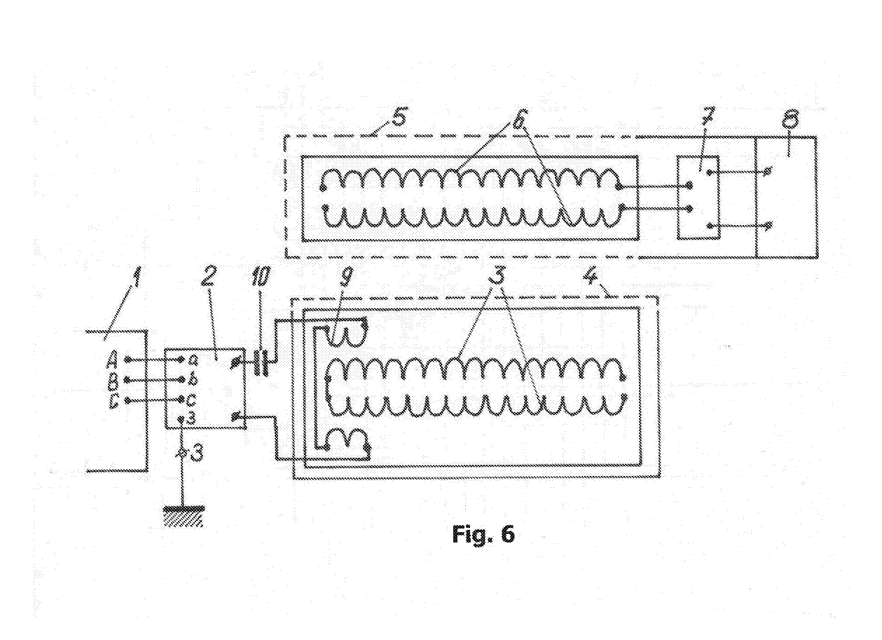

Splitting the supply coupling winding 9 in the transmitter 4 increases the reliability of the process of pumping energy into the double-wire spiral winding 3 (FIG. 6) due to two-way energy pumping into the double-wire spiral winding 3, which makes the thermal conditions easier for the double-wire spiral winding 6 and simplifies the cooling conditions of the unit for pumping energy into the charger.

A sample method and device for wireless charging of electrical energy storage in a fixed or mobile consumer.

Case 1. The supply transmission coil or the double-wire spiral winding 3 includes a double copper wire with cross-section area of 0.75 mm², 90 turns. Winding conductors are located in the same plane, forming a double-wire Archimedean spiral. The inner diameter of the spiral winding is 100 mm, the outer diameter is 480 mm. The inductance of each spiral is 5.1 mH. The double-wire spiral winding is a quarter-wave open-end long line coiled into a flat spiral. Line ends are insulated from each other. The capacitance between spiral wires is 30.5 nF. The resistance of conductors in the double-wire spiral winding is 2.3Ω and 2.4Ω. The resonant frequency is f₀=64-60 kHz. The coil or the winding 6 of the receiver 5 represents a flat single-wire spiral winding with inner diameter of 100 mm. The winding inductance is 0.3 mH. Electrical energy with power of 100 W and dissipation of maximum 7% was pumped at a distance of 0.5 m in a vertical direction between the winding 3 of the transmitter 4 and the winding 6 of the receiver 5 when moving in two mutually transversal directions in a horizontal plane (±0.3 m from the center).

Case 2. In the energy transmission conditions as per Case 1, energy was pumped into the supply transmission coil or the double-wire spiral winding 3 using pumping winding or the supply coupling winding 9. The supply coupling winding 9 is made of copper wire with cross section area of 2.5 mm², 3 turns. The inductance of the winding 9 is 18.5 μH. The winding 9 is connected to the output of the converter 2 via the electrical capacitor 10 connected in series. The capacitance of the capacitor 10 is 180 nF. The leads of the winding 3 were short circuited. Peripheral measurements of transmitter power dissipation under the same test conditions as per Case 1 yielded similar results for dissipation at a deviation of the receiver winding from the center by ±0.3 m, no more than 7%.

Under the conditions of power transmission as per Case 1 and Case 2, energy with power of 100 W was transmitted to a distance of 1.0 m. Dissipation was 10% maximum.

Thus, power transmission tests at distances of 0.5 m and 1.0 m proved that the irregularity of electromagnetic field intensity for low-power gadgets, such as mobile phones, laptops, tablet, PCs etc. at an area of about 0.3 m² is no worse than 10%. The average electromagnetic energy flux intensity in this case was equal to about 0.3 kW/m2.

Case 3. The transmission supply coil or the double-wire spiral winding 3 includes a double copper multi-conductor wire PVMTg-40 with cross section area of 0.25 mm², the insulation strength is 40 kV DC, and the outer diameter in insulation is 4.2 mm. The winding 3 is in the form of a flat rectangular spiral with outer dimensions of 2.5 m×1.0 m. The number of double turns is 150. The inner leads of the winding 3 are insulated from each other. The outer ones are connected to the supply frequency converter 2. The supply current frequency is 11 kHz. The inductance of each branch in the double-wire spiral winding 3 is 6.2 mH. DC resistance of each branch is 11Ω. The receiver coil or the winding 6 includes copper multi-core wire with cross section area of 16 mm2. The winding 6 has dimensions of 1.4 m×0.5 m. The number of turns is 25. Inductance is 1.2 mH. DC resistance is 0.16Ω. The distance between the winding 3 of the transmitter 4 and winding 6 of the receiver 5 is 0.3 m, the transmitted power is 2.0 kW.

The power irregularity in case of deviation from the central position towards any of the four sides by 0.5 m was 10% maximum. The average electromagnetic energy flux intensity was equal to about 3.0 kW/m2.

Thus, the electrical energy flux irregularity tests for transmission to a distance of 0.3 mat power of 2.0 kW by displacing the receiver coil by ±0.5 m (half width of transmission coil) proved that power deviations do not exceed 10%.

The device as per Case 3 can be used for charging batteries of mobile gadgets such as cars, electric carts or quadcopters, without any stringent requirements for mutual positioning of the charger and the serviced unit or gadget. Several gadgets can be serviced simultaneously in parallel. The proposed invention offers the possibility of wireless charging of electrical energy storages in a fixed or mobile electrical consumer, i.e.: charging and recharging of electrical energy storages in vehicles during movement or at special wireless charging stations, when a mobile electrical consumer is present at a road crossing with traffic lights, etc., for charging and recharging energy storages in mobile phones, laptops, tablet PCs in large rooms, charging and recharging energy storages in quadcopters, automated logistical systems of cargo movement at large warehouses and bases and storages under operating conditions of automated systems where presence of people is undesirable (warehouses with very low operating temperatures, warehouses with special composition of ambient environment, etc.).

What is claimed is:

1. A method of wireless charging of electrical energy storage of a fixed or mobile power consumer, the method comprising the steps of:
transmitting electrical energy from a power source to the electrical energy storage of the fixed or mobile power consumer using a controlled and frequency-adjustable electrical current converter for conversion from a power source format to a high frequency AC current format;
including a transmitter and a receiver with magnetic resonance coupling and a current converter for conversion from the high frequency AC current format into a current format required for normal operation of the electrical energy storage being charged, wherein a magnetic resonance winding of the transmitter includes a flat double-wire spiral winding from a center to a periphery thereof, wherein a magnetic resonance winding of the receiver includes a flat single-wire spiral winding, and wherein the magnetic resonance winding of the transmitter is used for exciting current and potential standing waves with maximum current at the periphery of the magnetic resonance winding of the transmitter; and
arranging energy transmission between the transmitter and the receiver using an electromagnetic field, wherein leads in the center of the magnetic resonance winding of the transmitter are connected to output terminals of the controlled and frequency-adjustable electrical current converter, and wherein leads in a periphery of the magnetic resonance winding of the receiver are connected to the current converter for conversion from the high frequency AC current format into the current format required for normal operation of the electrical energy storage being charged.

2. The method of wireless charging of electrical energy storage of a fixed or mobile power consumer according to claim 1, wherein the magnetic resonance winding of the receiver includes a flat double-wire spiral winding running from a center to the periphery thereof, wherein a natural resonant frequency of the magnetic resonance winding of the receiver is equal to a resonant frequency of the magnetic resonance winding in the transmitter, wherein leads in the center of the magnetic resonance winding of the receiver are insulated from each other and from other conductive parts and components of the receiver, wherein the leads in the periphery of the magnetic resonance winding of the receiver are connected to an input of the current converter for conversion from the high frequency AC current format into the current format required for normal operation of the electrical energy storage being charged, and wherein an output of the current converter for conversion from the high frequency AC current format into the current format required for normal operation of the electrical energy being charged is connected to inlet terminals of the electrical energy storage at the receiver.

3. The method of wireless charging of electrical energy storage of a fixed or mobile power consumer according to claim 1, wherein leads in the periphery of the magnetic resonance winding of the transmitter are short-circuited and power from the output terminals of the controlled and frequency-adjustable electrical current converter is fed to the magnetic resonance winding of the transmitter using a supply coupling coil, and wherein the supply coupling coil covers the flat double-wire spiral windings of the magnetic resonance winding of the transmitter at the periphery on a same plane as the magnetic resonance winding of the transmitter.

4. The method of wireless charging of electrical energy storage of a fixed or mobile power consumer according to claim 3, wherein the supply coupling coil is connected to the output terminals of the controlled and frequency-adjustable electrical current converter via a capacitor forming a series resonant loop, and wherein a natural resonant frequency of the series resonant loop is equal to a resonant frequency of the magnetic resonance winding of the transmitter.

5. The method of wireless charging of electrical energy storage of a fixed or mobile power consumer according to claim 1, wherein the magnetic resonance winding of the receiver is connected to an input of the current converter for conversion from the high frequency AC current format into the current format required for normal operation of the electrical energy storage being charged via a capacitor forming a series resonant loop, and wherein a resonant frequency of the series resonant loop is equal to a resonant frequency of the magnetic resonance winding of the transmitter.

6. The method of wireless charging of electrical energy storage of a fixed or mobile power consumer according to claim 4, wherein the supply coupling winding includes a pair of circular half-windings located along a periphery thereof at opposite ends of the flat double-wire spiral winding of the magnetic resonance winding of the transmitter, and wherein the pair of circular half-windings are electrically interconnected in series and consistently.

7. A system for wireless charging of electrical energy storage of a fixed or mobile consumer comprising:
a power source coupled to a controlled and frequency-adjustable electrical current converter for converting current from a power source format to a high frequency AC current format;
a transmitter and a receiver with magnetic resonance coupling; and
a current converter for converting the current from the high frequency AC current format into a current format required for normal operation of the electrical energy storage being charged, wherein a magnetic resonance winding of the transmitter includes a flat double-wire spiral winding from a center to a periphery thereof, wherein a magnetic resonance winding of the receiver includes a flat single-wire spiral winding, wherein electric energy is transferred between the magnetic resonance winding of the transmitter and the magnetic resonance winding of the receiver using an electromagnetic field, wherein leads in the periphery of the magnetic resonance winding of the transmitter are connected to output terminals of the controlled and frequency-adjustable electrical current converter, wherein leads of the center of the magnetic resonance winding of the transmitter are insulated from each other and from other conductive parts and components of the transmitter, wherein leads in a periphery of the magnetic resonance winding of the receiver are coupled to input terminals of the current converter for converting the high frequency AC current into the current format required for normal operation of the energy storage being charged, and wherein output terminals of the current converter for converting the high frequency AC current into the current format required for normal operation of the energy storage being charged are connected to terminals of the electrical energy storage in the receiver of the fixed or mobile consumer.

8. The system for wireless charging of electrical energy storage of a fixed or mobile consumer according to claim 7, wherein the magnetic resonance winding of the receiver includes a flat double-wire spiral winding running from a center to the periphery thereof, wherein leads in the center of the magnetic resonance winding of the receiver are insulated from each other and from other conductive parts and components of the receiver, and wherein a natural resonant frequency of the magnetic resonance winding of the receiver is equal to a resonant frequency of the magnetic resonance winding of the transmitter.

9. The system for wireless charging of electrical energy storage of a fixed or mobile consumer according to claim 7, wherein the leads in the periphery of the magnetic resonance winding of the transmitter are short-circuited, wherein a supply coupling coil couples the magnetic resonance winding of the transmitter with the controlled and frequency-adjustable electrical current converter, wherein the supply coupling coil is located in the same plane of the magnetic resonance winding of the transmitter, and wherein supply coupling coil leads are connected to the output terminals of the controlled and frequency-adjustable electrical current converter.

10. The system for wireless charging of electrical energy storage in a fixed or mobile power consumer according to claim 9, wherein the supply coupling coil is connected to the output terminals of the controlled and frequency-adjustable electrical current converter via a capacitor forming a series resonant loop of the transmitter, wherein a natural resonant frequency of the series resonant loop of the transmitter is equal to a natural resonant frequency of the magnetic resonance winding of the transmitter.

11. The system for wireless charging of electrical energy storage in a fixed or mobile power consumer according to claim 10, wherein the leads in the periphery of the magnetic resonance winding of the receiver are connected to the input terminals of the current converter for converting the high frequency AC current into the current format required for normal operation of the energy storage being charged via a capacitor forming a series resonant loop of the receiver, and wherein a resonant frequency of the series resonant loop of the receiver is equal to the resonant frequency of the magnetic resonance winding of the transmitter.

12. The system for wireless charging of electrical energy storage in a fixed or mobile power consumer according to claim 9, wherein the supply coupling coil includes two circular half-windings located along the periphery thereof at opposite ends of the flat double-wire spiral winding of the magnetic resonance winding of the transmitter, and wherein the pair of circular half-windings are interconnected in series and consistently.
